(19) United States
(12) Patent Application Publication
(10) Pub. No.: US 2006/0161631 A1
(43) Pub. Date: Jul. 20, 2006

(54) Revisions of already sent messages in an instant messaging communication

(76) Inventor: Luigi Lira, Costa Mesa, CA (US)

Correspondence Address: Luigi Lira, 2973 Harbor Blvd #198, Costa Mesa, CA, 92626, US

(21) Appl. No.: 11/171,737

(22) Filed: Jun. 30, 2005

Related U.S. Application Data
(60) Provisional application No. 60/644,660, filed on Jan. 18, 2005.
(60) Provisional application No. 60/674,615, filed on Apr. 25, 2005.

(51) Int. Cl. G06F 15/16; G06F 17/21; G06F 17/24

(52) U.S. Cl. 709/206; 715/526

(57) ABSTRACT

This invention relates to instant messages. More particularly, the invention relates to the delivery of revisions of instant messages that have already been previously delivered from a sender's instant message client to at least one recipient's instant message client during an instant messaging communication. Typically, revisions are made by the original sender of the instant message with the intent to correct misspellings or mistakes. Also, typically, an instant message client displays a revised instant message differently from an unrevised one with the purpose to bring revisions to the attention of the user, and so not to be mistaken for original content. In addition, the instant message client may mark or change the display of the original message that has been superseded by the revised message.

### CROSS REFERENCE TO RELATED APPLICATIONS

This application claims priority to U.S. provisional patent application Ser. Nos. 60/644,660, filed 18 Jan. 2005 and 60/674,615, filed 25 Apr. 2005, which applications are incorporated herein in their entirety by this reference thereto.

This application also incorporates herein in its entirety by this reference thereto disclosure document no. 568,973, which was received at the U.S. Patent Office on 25 Jan. 2005, and disclosure document no. 574,932, which was received at the U.S. Patent Office on 15 Apr. 2005.

### BACKGROUND OF THE INVENTION

1. Technical Field

This invention relates to instant messages. More particularly, the invention relates to the delivery of revisions of instant messages that have already been previously delivered from a sender's instant message client to at least one recipient's instant message client during an instant messaging communication. Typically, revisions are made by the original sender of the instant message with the intent to correct misspellings or mistakes. Also, typically, an instant message client displays a revised instant message differently from an unrevised one with the purpose to bring revisions to the attention of the user, and so not to be mistaken for original content. In addition, the instant message client may mark or change the display of the original message that has been superseded by the revised message.

2. Description of the Prior Art

An instant message (IM) is a form of electronic communication between users of a computer network in which a message is delivered instantly and without the recipient having to access an e-mail program or otherwise check for messages. An instant message appears essentially as soon as the message sender clicks the send button, subject to any time or propagation delays the message may have encountered on the network. In comparison to most e-mail applications, instant messaging enables users to communicate with each other in a more dynamic, interactive, and entertaining manner.

FIG. 4A shows a simplified session window 100 that contains the user interface basic elements. These basic elements are featured in the user interface of the major IM services, such as those from America Online, Inc., Yahoo, Inc., and Microsoft, Inc. The basic elements of the user interface are a transcript area 101 where the messages from all the users involved in the communication are displayed in their chronological order as they are sent; a message composition area 102 where the user inputs the message to send to the other parties involved in the communication; and a send button 103 that the user selects when ready to send the message. Typically, the user interface also contains many other elements, for example, a control to select the font of the message, a control to select the font size of the message, and a control to select the color of the message text, among others. Those extra elements are not relevant for the herein description.

For the purpose of illustrating an IM communication, FIG. 4B shows a session window 100 where two users have exchanged a few messages. The message address field 111 shows which user sent the message. The currently available IM services are able to send text content 112 formatted with font, size, color, and other attributes chosen by the sender. They are also able to send emoticon graphic content 113. So-called emoticons are small to medium sized images or graphics, typically depicting cartoon-like smiling, winking, or sad faces. Emoticons are generally provided by the IM service itself, and are accessible to the sender by means of a user interface element, for example, a pop-up or a sub window.

Messages in an instant message communication are typically quickly typed and sent. Often a sender realizes a misspelled word or a mistake (e.g. “see you tomorrow” instead of “see you tonight”) in a message only after he has already sent it.

Prior art provides no support for revisions of already sent messages, leaving the sender with the task of, for example, rewriting the whole message with the correction or writing a message pointing out the mistake and providing the correction.

### SUMMARY OF THE INVENTION

The herein disclosed invention lets a sender revise an already sent message in respect of making the revision and the revised message evident as such to a recipient. Herein are also disclosed means to prevent the misuse of this feature by a user to tamper with the transcript of a communication.

In the preferred embodiment, a sender's client may allow a sender client system to modify, for example, automatically (e.g. as a result of a software process) or upon sender's input (e.g. a sequence of at least one click or keystroke) a message that has already been delivered to the recipients involved in the communication session. Once modified, the sender's client may allow the sender client system to deliver the revision (e.g. the modified message, the original messages plus the modifications, or the modifications only) to the recipients. Along with the revision, the sender's client may deliver also an identification of the original message that has been revised (e.g. the unique ID, the time-stamp, or the sequential position of the message.)

Typically, after a revision has been delivered, all clients participating in the communication (i.e. the recipient's client, or recipients' clients, and the sender's client) display the revised message.

The form in which the revised message is displayed may be defined by the sender's client system and/or the form in which the revised message is displayed may be enforced by a recipient's client.

The form in which the revised message is displayed may vary from client to client, accordingly to the parameters set for each client (i.e. parameters related on how to display a revised message) by, for example, the client system (e.g. automatically or upon user input). Although, typically, an instant message client displays a revised instant message differently from an unrevised one with the purpose to bring revisions to the attention of the user, and so not to be mistaken for original content. Also typically, when a revised message doesn't override the display of the original message, the original message is, for example, marked, strikeout, or otherwise displayed as superseded by the revised message.

FIG. 1 is an example of an instant messenger session window 100 belonging to an instant messenger client application. The instant messenger session window 100 is displaying several messages, 350, 360, 370, 380 and 390, of which message 370 is the original message that has been revised by message 390.

The example of FIG. 1 displays a chronological sequence of messages exchanged between two users, “Sandy” (i.e. a sender whose username is Sandy) and “Richard” (i.e. a sender whose username is Richard.) The first message exchanged is message 350, “Hello”, from Sandy. The second message exchanged is message 360, “Hi”, from Richard.

The third message exchanged is message 370 from Sandy, originally sent as “Nice to see you” and subsequently revised, by Sandy, into “Nice to talk to you”. The message 370 is displayed in strikeout text because it has been superseded by the revised message 390.

The revision contained in the revised message 390, “Nice to talk to you”, consists of the deletion of the word 395, “see”, which is displayed in red and stricken-out, and the addition of the words 396 “talk to”, which are displayed in green.

Before the message 370 was revised, a fourth message, message 380, “Same here”, from Richard was delivered. As it is noticeable, the revision of message 370 took place without altering the chronological sequence of messages.

### BRIEF DESCRIPTION OF THE DRAWINGS

FIG. 1 provides an example of a session window containing a revised message;

FIG. 2 provides a general overview of a computer communication network;

FIG. 3A provides an example of a client user interface for a desktop computer;

FIG. 3B provides an example of a client user interface for a PDA;

FIG. 3C provides an example of a client user interface for an advanced cellular phone;

FIG. 4A provides an example of a session window containing elements of a user interface;

FIG. 4B provides an example of a session window where two users have exchanged messages;

FIG. 5 provides a flow-chart of the steps to select, revise, deliver, and display a revision;

FIGS. 6A and 6B provide an example of two users before a message revision;

FIGS. 7A and 7B provide an example of two users during a message revision;

FIGS. 8A and 8B provide an example of two users after a message revision;

FIGS. 9A through 9E provide examples of displays of a revised message;

FIG. 10 provides an example of an archived transcript in plain text format; and

FIG. 11 provides an example of an archived transcript in XML format.

### DETAILED DESCRIPTION OF THE INVENTION

In the preferred embodiment, a sender's client may allow a sender client system to modify, for example, automatically (e.g. as a result of a software process) or upon sender's input (e.g. a sequence of at least one click or keystroke) a message that has already been delivered to the recipients involved in the communication session. Once modified, the sender's client may allow the sender client system to deliver the revision (e.g. the modified message, the original messages plus the modifications, or the modifications only) to the recipients. Along with the revision, the sender's client may deliver also an identification of the original message that has been revised (e.g. the unique ID, the time-stamp, or the sequential position of the message.)

Typically, after a revision has been delivered, all clients participating in the communication (i.e. the recipient's client, or recipients' clients, and the sender's client) display the revised message.

The form in which the revised message is displayed may be selected by the sender's client system. The form in which the revised message is displayed may vary from client to client depending upon the parameters set for each client (i.e. parameters related on how a revised message is displayed) by, for example, the client system (e.g. automatically or upon user input), that may override the sender's client system selection. Typically, an instant message client displays a revised instant message differently from an unrevised one with the purpose to bring revisions to the attention of the user, and so not to be mistaken for original content. Also typically, when a revised message doesn't override the display of the original message, the original message is, for example, marked, strikeout, or otherwise displayed as superseded by the revised message.

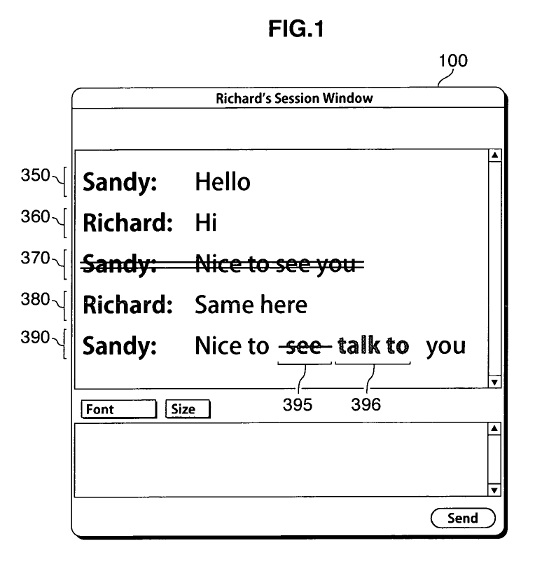

FIG. 1 is an example of an instant messenger session window 100 belonging to an instant messenger client application. The instant messenger session window 100 is displaying several messages, 350, 360, 370, 380 and 390, of which message 370 is the original message that has been revised by message 390.

The example of FIG. 1 displays a chronological sequence of messages exchanged between two users, “Sandy” (i.e. a sender whose username is Sandy) and “Richard” (i.e. a sender whose username is Richard.) The first message exchanged is message 350, “Hello”, from Sandy. The second message exchanged is message 360, “Hi”, from Richard.

The third message exchanged is message 370 from Sandy, originally sent as “Nice to see you” and subsequently revised, by Sandy, into “Nice to talk to you”. The message 370 is displayed in strikeout text because it has been superseded by the revised message 390.

The revision contained in the revised message 390, “Nice to talk to you”, consists of the deletion of the word 395, “see”, which is displayed in red and stricken-out, and the addition of the words 396 “talk to”, which are displayed in green.

Before the message 370 was revised, a fourth message, message 380, “Same here”, from Richard was delivered. As it is noticeable, the revision of message 370 took place without altering the chronological sequence of messages.

The following description defines a typical instant message environment.

Typically, instant message (IM) communications involve an instantaneous or nearly instantaneous communication between two or more users, where each user is able to transmit, receive, and display communicated information. Additionally, although IM communications may occur in the absence of online presence information, IM communication generally involves the display and perception of online presence information regarding other selected users (“buddies”). After a communication session is established or authentication is performed, the IM communications may be machine-to-machine communications that occur without intervention by, or communication through, an instant messaging server. Examples of IM communications exist over AIM (America Online Instant Messenger), AOL (America Online) buddy list and Instant Messenger, Yahoo Messenger, MSN Messenger, and ICQ, among others.

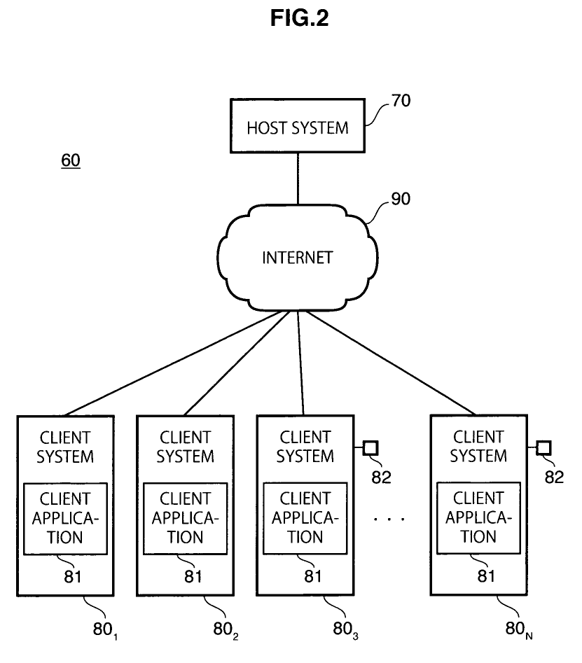

FIG. 2 illustrates a general overview of a computer communication network 60 including a host system 70 (i.e. an IM server.) In computer network 60, client systems 80.sub.1 to 80.sub.N (i.e. the IM client systems), are coupled through the Internet 90, or other communication network, to the host system 70. Only one host system 70 is shown, but it is understood that more than one host system can be used and that other servers providing additional functionality may also be interconnected in network 60 directly, over a LAN or a WAN, or over the Internet. Several elements in the system shown in FIG. 2 are conventional, well-known elements that need not be explained in detail here.

The herein described invention is suitable for use with the Internet, which for purposes of the discussion herein refers to a specific global inter-network of networks. However, it should be understood that other networks can be used instead of the Internet, such as an intranet, an extranet, a virtual private network (VPN), a wireless network (e.g. GPRS), an ATM network, non-TCP/IP based network, or the like.

According to one embodiment, the host system 70 and all of its components are operator-configurable using computer code run using a central processing unit. Computer code for operating and configuring the host system 70 is preferably stored on a hard disk, but the entire program code, or portions thereof, may also be stored in any other memory device, such as a ROM or RAM, or provided program code, such as a compact disk medium, a floppy disk, or the like.

Each client system 80, for example, could be a desktop personal computer, workstation, cellular telephone, personal digital assistant (PDA), music or video player, laptop, or any other computing device capable of interfacing directly or indirectly to the Internet. Each client system 80 also typically includes one or more user interface devices 82, such as a keyboard, a mouse, touch-screen, pen or the like, for interacting with a client 81 (i.e. an IM client application), by means of a client user interface (i.e. a graphical user interface provided by client itself), and for interacting with any other application, program, and software or similar entity by means of their respective user interfaces.

An example of a client 81 is a software application loaded on the client system 80 for commanding and directing communications enabled by the client system 80. Other examples include a program, a piece of code, an instruction, a firmware, an embedded capability, a device, a computer, a computer system, or a combination of these for independently or collectively instructing the client system 80 to interact with the host system 70 and operate as described. The client 81 may be embodied permanently or temporarily in any type of machine, component, physical or virtual equipment, storage medium, or propagated signal capable of providing instructions to the client system 80.

A client 81 could also be software which primary use is not for instant messaging, but nevertheless, has full or partial instant messaging capabilities, for example, a multipurpose communication software (e.g. America Online Inc., AOL 9.0), IRC software, word processing and spreadsheet applications having networking capabilities, web browsers (e.g. Mozilla or Netscape Communicator), web browsers in conjunction with instruction received from a web site (e.g. America Online Inc., AIM Express), and video, audio, or multimedia communication software.

To access the host system 70 to begin an IM session in the implementation of FIG. 2, the client system 80.sub.1 establishes a connection to the host system 70. Once the connection to the host system 70 has been established, the client system 80.sub.1 may directly or indirectly transmit data to, and access content from, the host system 70. By accessing the host system 70, a user can use the client 81 to view whether particular users (“buddies”) are online, exchange IMs with particular buddies, participate in group chat rooms, trade files such as pictures, invitations or documents, and find other buddies with similar interests. The client system 80.sub.2 may be similarly manipulated to establish contemporaneous connection with the host system 70. In certain system embodiments, the client system 80 may act as a substitutive equivalent of the host system 70 to other client systems 80 (e.g. a Gnutella-like or Limewire-like decentralized P2P communication network.)

Once connectivity is established, a user who is using the client system 80.sub.1 may view whether a second user operating, for example, the client system 80.sub.2 is online, and typically may view whether the second user is able to receive IMs. If the second user is online, the user operating the client system 80.sub.1 may exchange IMs with the second user. In one implementation, the IMs sent between the client system 80.sub.1 and the client system 80.sub.2 are routed through the host system 70. In another implementation, the IMs sent between the client system 80.sub.1 and the client system 80.sub.2 are routed through a third party server (not shown), and, in some cases, are also routed through the host system 70. In yet another implementation, the IMs are sent directly between the client system 80.sub.1 and the client system 80.sub.2.

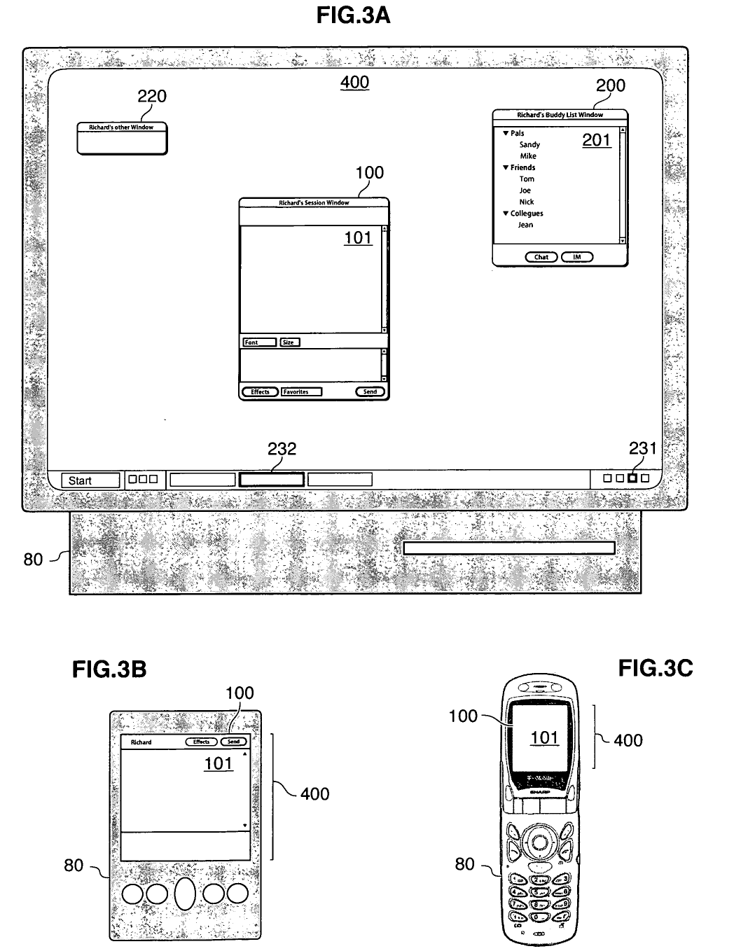

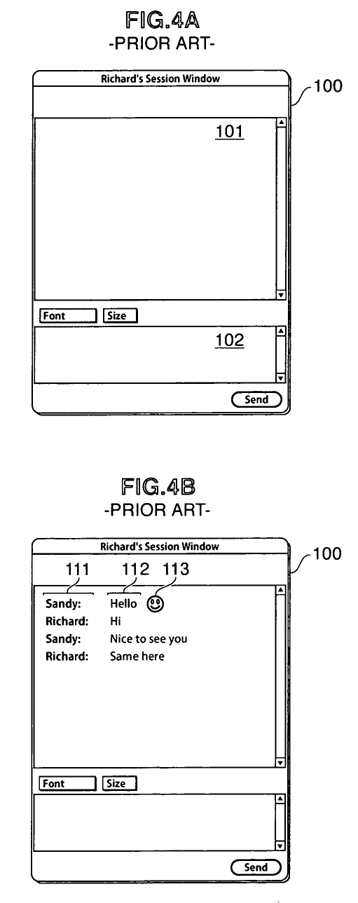

The client user interface is the graphic user interface generated by the client 81 to display to the user information related, for the most part, to the IM communication. Referring to FIG. 3A, in one embodiment where the client system 80 is, for example, a desktop computer, the client user interface is usually constituted by one or more session windows 100, a buddy list window 200, and often, other miscellaneous windows, e.g. window 220 all displayed on a screen 400. The client user interface also usually comprises one, or more, of the icon 231 and window locator 232 related to the client 81 of FIG. 2.

Referring to FIG. 3B, in one embodiment where the client system 80 is, for example, a PDA, the visible portion of the client user interface usually alternates, due to the small size of the screen 400, between a session windows 100, a buddy list window, and other miscellaneous windows.

Referring to FIG. 3C, in one embodiment where the client system 80 is, for example, an advanced cellular phone, the visible portion of the client user interface usually alternates, due to the small size of the screen 400, between a session windows 100, a buddy list window, and other miscellaneous windows. On some advanced cellular phones the transcript area 101 is the only visible element of the user interface for the session windows 100 and such transcript area 101 covers the entire screen 400. On other advanced cellular phones, the user interface may resemble and be more similar to the user interface of a PDA or of a portable computer.

Referring to FIG. 3A, FIG. 3B, and FIG. 3C the session window 100 typically contains, among other user interface items, the transcript area 101. The transcript area contains the visible portion of the transcript of the IMs that have been exchanged between the user of the client system 80 and the other users participating in the IM session. Hence, the terms transcript and transcript area are herein used.

To clarify, the client system is usually a hardware entity. The client is usually a software entity having a client user interface comprising the session window and often other windows (e.g. a buddy list window) and frequently other session windows. The session window typically comprises the transcript area, where the user can see the IMs exchanged during the session. The sender and the recipient are usually human beings, although sometimes they can be hardware or software automated processes. A user is alternately sender or recipient depending whether he is sending an IM or receiving one. Typically, a user swaps between the roles of sender and recipient every few seconds.

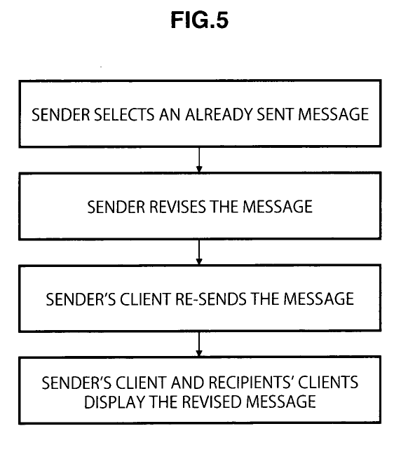

FIG. 5 shows the preferred embodiment steps that take place to select an already sent message, revise the message, deliver the revision, and update the display of a revised message.

In the preferred embodiment, the process of revising a message starts with the selection of an already sent message. The selection is made by a client system, for example, automatically (e.g. as a result of a software process) or upon a sender's input (e.g. a sequence of at least one click or keystroke.)

Once the message is selected, the client may provide means to generate a revision of the message. For example, a copy of the message may be loaded into a message composition area (e.g. the message composition area 102 of FIG. 7A) to allow the client system to revise the message. Other examples may be: a copy of the message may be loaded in another preset area of the user interface (e.g. a window or a pane) or the revised message may be prepared “in place” (i.e. the user prepares the message directly in the transcript area.)

During the preparation of a revision, the instant messenger client may alter its normal user interface (e.i. the UI displayed while not preparing a revision) to aid the user in the preparation process. Such alteration may comprise of, for example, a mean to bring to the user attentions which message is under revision (e.g. an highlighting of the message), a mean to bring to the user attentions that he is preparing a revision and not a regular message (e.g. a warning mark), and means to commit (i.e. request to delivery) or rollback (i.e. abort) the revision (e.g. a Revise and a Cancel button.)

Once the message is revised, the revision (e.g. the modified message, the original messages plus the modifications, or the modifications only) may be delivered to the instant messenger clients involved in the communication.

Once an instant messenger client receives the revision, it may, for example, display the revised message according to the parameters set by its user.

In exceptional cases, a recipient's client may reject the revision. If a revision is rejected, the rejecting client may notify the sender's client of the rejection.

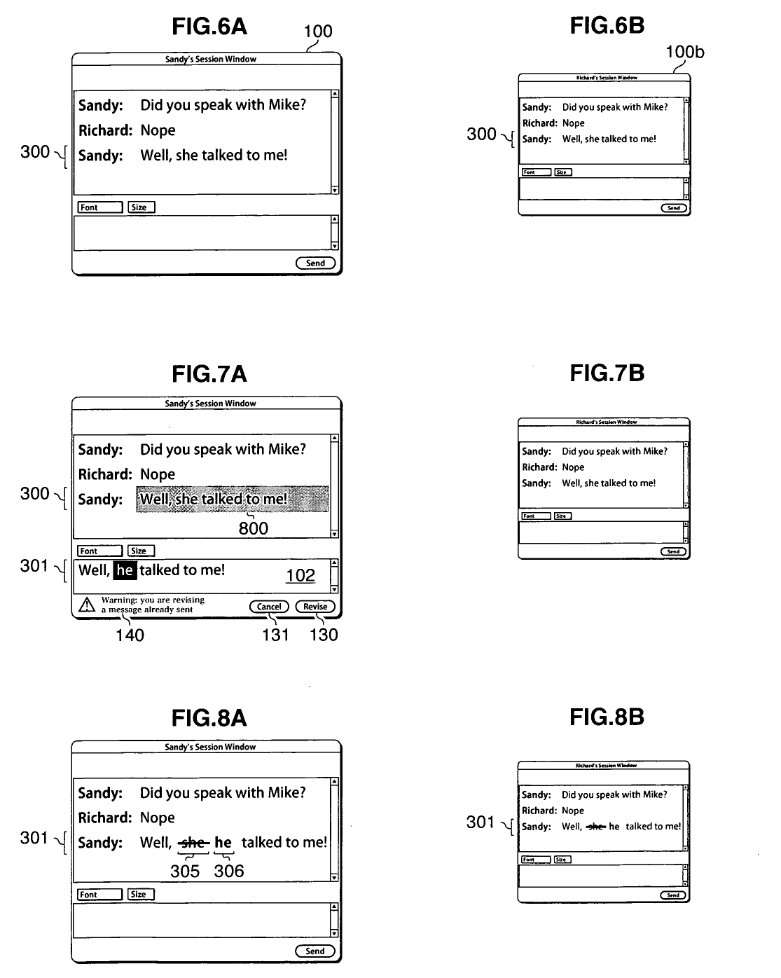

FIGS. 6A and 6B show an example of instant messenger session windows before a message is selected and revised.

FIG. 6A shows the instant messenger session window 100 belonging to “Sandy” (i.e. a sender whose username is Sandy), who is the sender of message 300, “Well, she talked to me!”. FIG. 6B shows the instant messenger session window 100b belonging to a second party involved in the communication, “Richard” (i.e. a sender whose username is Richard), who is the recipient of the message 300.

FIGS. 7A and 7B show an example of instant messenger session windows in which Sandy, the sender of message 300, “Well, she talked to me!”, after having selected the message 300 for revision, is now revising the message.

FIG. 7A shows Sandy's (i.e. the sender's) instant messenger session window 100 while she is revising the message 300, “Well, she talked to me!”, which is taking place after she selected it. Her selection of the message 300, has caused the message to be copied into the message composition area 102 where she is preparing the revised message 301, “Well, he talked to me!”.

It is noticeable that the user interface displays a warning indication 140 to alert the user that she is preparing a revision instead of a regular message, and the buttons 130, “Revise”, to deliver the revision, and 131, “Cancel”, to abort the revision. The current message under revision (i.e. the message 300) is brought to the attention of the user by the highlight 800.

After the user requests to deliver the revision, a confirmation dialog, for example, a window displaying a confirmation request (not shown in the drawing) may be displayed to the sender.

FIG. 7B displays Richard's (i.e. the recipient's) instant messenger session window, and it is noticeable that nothing has changed while Sandy (i.e. the sender) is revising the message.

FIGS. 8A and 8B show an example of instant messenger session windows after Sandy (i.e. the sender of message 300, “Well, she talked to me!”) has requested her instant messenger client to deliver the revision. The revision message has been preselected by the sender's client system to be displayed in place of the original message, i.e. in the same location where the original message was; the original message is no longer visible. The recipient's client has been set to allow revision messages to be displayed in place of the original message.

FIG. 8A shows Sandy's (i.e. the sender's) instant messenger session window 100 in which the revised message 301, “Well, he talked to me!” is now displayed. The revised message shows the deletion of the word 305, “she”, which is displayed in red and stricken-out, and the addition of the word 306, “he”, which is displayed in green.

FIG. 8B displays Richard's (i.e. the recipient's) instant messenger session window, and it is noticeable that the same revised message 301, “Well, he talked to me!”, is now displayed and clearly shows the modifications from the original message.

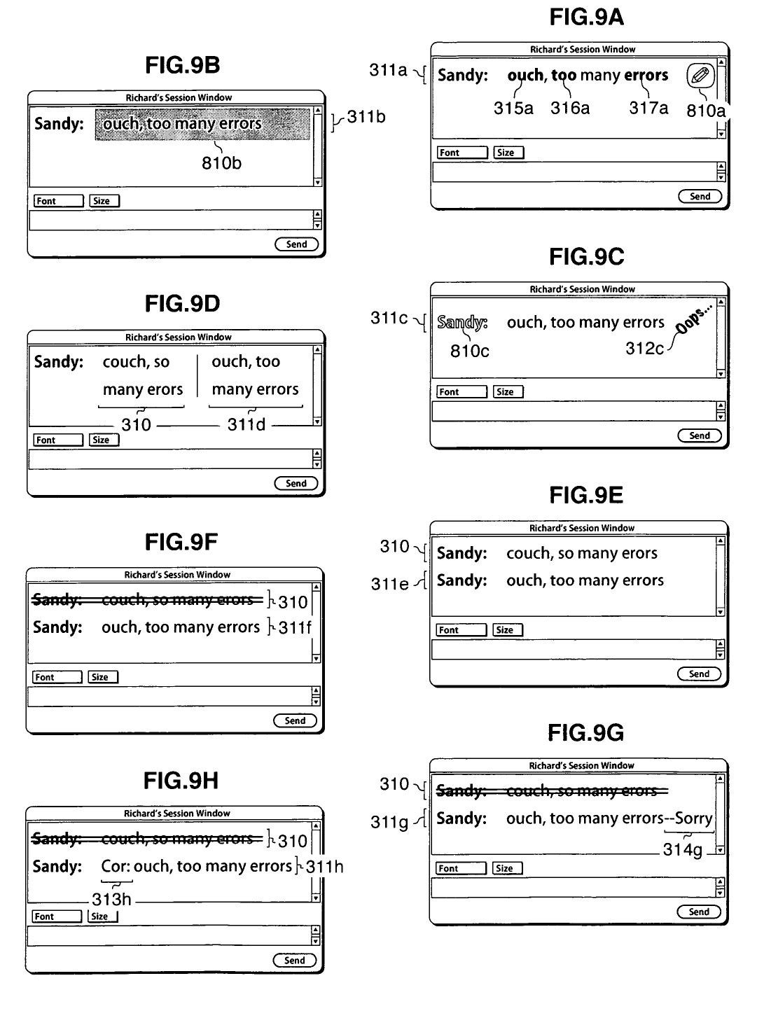

FIGS. 9A through 9H provide further examples of displays of a revised message.

The form in which the revised message is displayed may be selected by the sender's client system. The form in which a revised message is displayed may be based upon parameters preset by the recipient's client, set by the host system, or set by the recipient's client system, for example, automatically (e.g. as a result of a software process) or upon user input (e.g. a sequence of at least one click or keystroke) that override the sender's client system settings. In alternate embodiments, the form in which a revised message is displayed may be based upon features supported by the client, or lack of thereof.

FIG. 9A shows an example in which a revised message 311a is displayed in place of the original message and showing only the additions and not the deletions. The additions are the words 315a, “ouch”, 316a, “too”, and 317a, “errors”, which are shown in bold. The deletions (i.e. the words “couch”, “so”, and “erors”.) are not shown in accord with, for example, the parameter setting chosen by the recipient. A button 810a is displayed to both, alert the user that the message has been revised and, upon selection of the button, to let the user examine, for example, all alterations of the message (e.g. additions, deletions, and comments.)

FIG. 9B shows an example in which a revised message 311b is displayed in place of the original message. The only visual clue provided to alert the user of the revision is the altered background color 810b. The recipient may examine all the alterations of the message (e.g. additions, deletions, and comments), for example, by selecting the revised message for complete viewing (e.g. the user my click on the message and select an UI button, not shown in the drawing, provided for that purpose.)

FIG. 9C shows an example in which a revised message 311c is displayed in place of the original message. The only visual clue provided to alert the user of the revision is the outlined sender's username 810c. The artwork 312c, “Oops . . . ” is a comment part of the revision to draw additional attention to a revised message.

FIG. 9D shows an example in which a revised message 311d is displayed next to the superseded original message 310.

FIG. 9E shows an example of a “bare-bone” alternative embodiment, in which a revised message 311e is displayed without any visual clues of being a revised message. In this alternative embodiment, the original message 310 (i.e. the message which supersedes the revised message.) is left unmodified after the revision is received and processed (i.e after the revised message 311e is displayed.) It is up to the recipient to figure out that the revised message 311e is in fact a revision of message 310.

FIG. 9F shows an example in which a revised message 311f is displayed after the original message 310. The original message 310 is displayed in strikeout text to indicate that it has been superseded by the revised message 311f.

FIG. 9G shows an example in which a revised message 311g is displayed after the original message 310. The original message 310 is displayed in strikeout text to indicate that it has been superseded by the revised message 311g. The revised message 311g contains a text comment 314g, “—Sorry”, that has been preselected by the sender's system client to be added as a postfix to revised messages generated by the sender's client system.

FIG. 9H shows an example in which a revised message 311h is displayed after the original message 310. The original message 310 is displayed in strikeout text to indicate that it has been superseded by the revised message 311h. The revised message 311h contains a text comment 313h, “Cor:”, that has been preselected by the sender's system client to be added as a prefix to revised messages generated by the sender's client system.

In the preferred embodiment, a recipient's client may also provide, for example, based upon recipient settings, other features as a mean to bring a revised message to the user attentions. Such features may comprise of, for example, an automatic scroll of the transcript to bring to visibility newly revised messages, a dialog alerting that a message has been revised, flashing items, audible clues, and an index of all revised messages. Furthermore, alternate embodiments may provide other forms of displays and alerts of revised messages, which, to be concise, have been omitted from the the herein mentioned specifications.

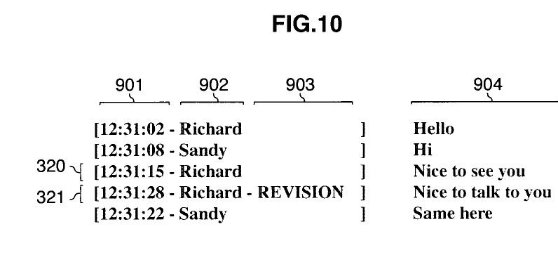

FIG. 10 provides an example of a revision included into a transcript of an instant message communication archived in plain text.

In the example of FIG. 10, the transcript of an instant message communication is archived in plain text (i.e. without any particular formatting.)

The archived transcript may be structured to show for each message a time-stamp 901 (i.e. when the message was sent), a sender 902 (i.e. who sent the message), a message-type 903 (i.e. information whether the message is original or revised), and the message body 904 (e.g. the text or content sent by the sender.)

The revised message 321 is recognizable as such by the value of its message-type that reads “REVISION”. The original message 320 (i.e. the message superseded by the revised message) is recognizable as such by immediately preceding the revised message 321. The time-stamp of the revised message 321 allows the actual chronological sequence of messages and revisions be reconstructed, if such reconstruction is needed.

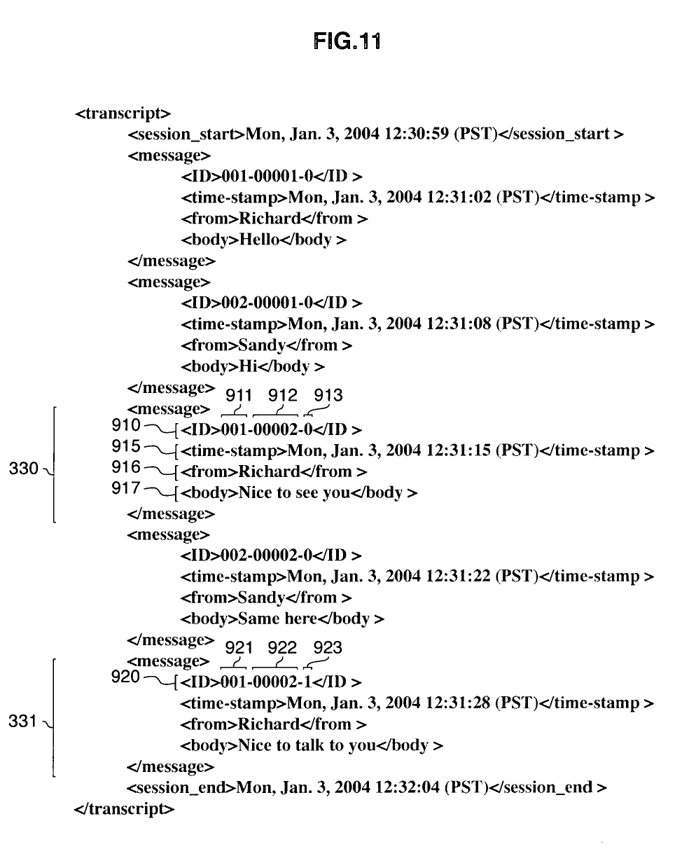

FIG. 11 provides an example of a revision included into a transcript of a instant message communication archived in XML.

Each message is archived in a “message” element (i.e. an XML element containing a message), such as element 330, which comprises of the start-tag “<message>” and the end-tag “</message>”. Between the start-tag and the end-tag lays the element content that comprises of several child elements.

Such child elements are an “ID” element 910 (i.e. the unique identifier of the message), a “time-stamp” element 915 (i.e. when the message was sent), a “from” element 916 (i.e. who sent the message), and a “body” element 917 (e.g. the text or content sent by the sender.)

The content of the “ID” element 910 is structured to allow for concurrent unique ID generation (i.e. when a client generates an unique ID concurrently with at least another client and the unique ID is guaranteed to be unique among all IDs generated.)

The ID field 911 is an unique ID of a client sending the message, the field 912 is an unique ID of the message within the messages sent by the client, and the field 913 identifies whether the message is original (e.g. the field value is 0) or the message is revised (e.g. the field value is >=0 and indicates the revision's chronological position among the revisions of a message.)

A revised message, such as the one contained in element 331, is recognizable as such by the “ID” element 920, which field 923 contains a non-zero value. The values of the fields 921 and 922 are the same as of the original message which the revised message supersedes.

For a revised message that comprises a comment, the comment may be contained, for example, in the “body” element or in a “comment” element (not shown in the drawing.)

The following description defines comments associated with a revision.

In the preferred embodiment, a sender's client may allow the sender to add at least one comment to a revision. A comment may be, for example, text selected from the revision and marked as comment or text added to the revision and marked as such. Example of text comment are the text 314g, “—Sorry”, shown if FIG. 9G and the text 313h, “Cor:”, shown in FIG. 9H.

A sender's client may also allow the sender to add at least one non-textual comment to a revision. Non-textual comments may be, for example, marks, icons, pictures, animations, sounds, or transient messages. An example of a non-textual comment is the artwork 312c, “Oops . . . ” shown if FIG. 9C.

A recipient's client may provide, for example, based upon recipient settings, the capability to display comments along with a revision for, for example, all revised messages, some revised messages, a particular revised message (e.g. one selected by the user to display its comments.)

A comment may be added to an empty revision, that is, a revision with no addition or deletion meant to deliver only at least one comment.

The following description defines non-textual alterations in revision.

In the preferred embodiment, a revision may comprise of non-textual alterations, for example, an addition of artworks (e.g. texts, graphics, images, animations, movies, or any combination of them, with or without sounds) to the original message, a stylistic alteration of some or all of the text of the original message, a deletion of an artwork from the original message.

The following description defines restrictions on the source of a revision.

In the preferred embodiment, the sender's client may restrict the sender client system from revising messages sent by other clients. In other words, “Sandy” (i.e. a sender whose username is Sandy) may revise only her own messages, and not messages sent by other users.

In the preferred embodiment, a recipient's client, and/or the host system, may enforce such restriction by rejecting a revision made by a client other than the original sender of the message. In other words, “Richard's” (i.e. a sender whose username is Richard) client may reject revisions made by Sandy when that revision modifies a message originally sent by somebody else other than Sandy. This feature, for example, prevents a tampered client from spoofing in a communication (e.g. an open-source instant messenger client modified and re-compiled for such a purpose.)

The restrictions based on the source of a revision may be, for example, set by the host system or arbitrated by the clients involved in the communication (e.g. automatically or upon user's input.)

The following description defines restrictions on the depth of a retrospective revision.

In the preferred embodiment, the sender's client may restrict the sender client system from revising any message except, for example, the last one sent, the last two sent, or the last N messages sent by the sender's client, where N is a preset number >=0. In other words, being N=1, Sandy may revise only her last messages, and not any messages sent before her last one. Only the messages sent by the sender's client are counted toward this restriction. In other words, being N=1, Sandy may revise her last message even when messages from one or more users have already been delivered after her last message (e.g. a message from Sandy saying “hello” is followed by a message from Richard saying “hi”, Sandy can still revise her “hello” message.)

In the preferred embodiment, a recipient's client, and/or the host system, may enforce such restriction by rejecting a revision of a message except when that message is, for example, the last one sent, the last two sent, or the last N messages sent by a client, where N is a preset number >=0. In other words, being N=1, Richard's client may reject a revision made by Sandy when that revision modifies a message other than her last one sent. This feature, for example, prevents a tampered client (e.g. an open-source instant messenger client modified and re-compiled for such a purpose) from spoofing an earlier part of the transcript, out of notice of the recipients, allowing the spoofing to go undetected after the transcript is archived.

In the preferred embodiment, the value of N (i.e. the number of messages before, and including, the last one sent) may be, for example, set by the host system or arbitrated by the clients involved in the communication (e.g. automatically or upon user's input.)

The following description defines restrictions on the amount of revisions applicable to a message.

In the preferred embodiment, the sender's client may restrict the amount a message can be revised to be lower than a preset maximum allowable amount. For example, the sender client system is allowed to modify up to 100% of the message text for messages having less than 5 words, up to 50% of the message text for messages having between 5 to 20 words, and up to 25% of the message text for messages having more than 20 words.

In the preferred embodiment, a recipient's client, and/or the host system, may enforce such restriction by rejecting revisions that modify a message by more than the preset maximum allowable amount of revision. The preset maximum allowable amount of revision may be, for example, set by the host system or arbitrated by the clients involved in the communication (e.g. automatically or upon user's input.)

The following description defines restrictions on the number of times revisions are applicable to a message.

In the preferred embodiment, the sender's client may restrict the number of times a message is revised to be lower than a maximum allowable amount. For example, a message my be revised only once, only twice, or only M times, where M is a preset number >=0. In other words, being M=1, “Sandy” (i.e. a sender whose username is Sandy) may revise a message and send its revision to “Richard” (i.e. a sender whose username is Richard) after which she is no more allowed to make further revisions to said already revised message. If M were =2, Sandy may revise a message and send its revision to Richard after which she is allowed to make one further revision to said already revised message and send its revision; after which she is no more allowed to make further revisions to said already twice revised message.

In the preferred embodiment, a recipient's client, and/or the host system, may enforce such restriction rejecting a revision of a message already revised by more than the preset maximum allowable amount of revision times. The preset maximum allowable amount of revision times may be, for example, set by the host system or arbitrated by the clients involved in the communication (e.g. automatically or upon user's input.)

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method, comprising the steps of:
providing an instant messaging client application user interface for an instant messaging communications session involving at least one instant message recipient and an instant message sender;
said at least one instant message recipient receiving a communication that comprises a message to be displayed to said at least one instant message recipient, said message being selected by said instant message sender;
said at least one instant message recipient receiving a communication that comprises a revision of said message, said revision being selected by said instant message sender; and
said revision comprising data to generate a revised message;
wherein said revised message is presented to said at least one instant message recipient.

2. The method of claim 1, wherein said revised message is presented to said at least one instant message recipient and said message is displayed as superseded.

3. The method of claim 1, wherein said revised message is presented to said at least one instant message recipient in place of said message.

4. The method of claim 1, said revision comprises at least one addition to said message.

5. The method of claim 1, said revision comprises at least one deletion from said message.

6. The method of claim 1, said revision comprises at least one comment.

7. The method of claim 1, wherein said revised message is presented to said at least one instant message recipient accordingly to parameters set by said instant message sender.

8. The method of claim 1, wherein said revised message is presented to said instant message recipient accordingly to parameters set by said instant message recipient.

9. The method of claim 1, further comprising the step of:
said instant messaging client application user interface of said instant message sender altering its display and behavior to accommodate the generation of said revision.

10. The method of claim 1, wherein said revised message is presented to said at least one instant message recipient and said message is displayed as superseded accordingly to any of the following formats:
said message is displayed in strikeout text;
said message is displayed in multiple strikeout text;
said message is displayed in underline text;
said message is displayed along with an icon identifing it as superseded;
said message is displayed along with a mark identifing it as superseded;
said message is displayed in red-like color; or
said message is displayed in blackened out.

11. The method of claim 1, wherein said revised message is presented to said at least one instant message recipient accordingly to any of the following formats:
additions, deletions, and comments being displayed with at least one set style;
additions and comments being displayed with at least one set style, and deletions being not shown;
additions being displayed with at least one set style, and deletions and comments being not shown;
additions and comments being displayed, and deletions being not shown; or
additions being displayed, and deletions and comments being not shown.

12. The method of claim 11, said additions, deletions, and comments being displayed with any of the following styles:
green-like or blue-like color for additions;
red-like color for deletions; and
strike-out text for deletions.

13. The method of claim 1, wherein said revised message is presented to said at least one instant message recipient accordingly to any of the following placements:
said revised message replaces the display of said message;
said revised message displayed next to said message;
said revised message displayed below to said message; or
said revised message displayed without relation to said message.

14. The method of claim 1, wherein said revised message is presented to said at least one instant message recipient along with at least one mean to differentiate to said at least one instant message recipient said revised message from a non revised message:

15. The method of claim 14, wherein said mean to differentiate to said at least one instant message recipient said revised message from a non revised message is any of the following:
a set background display for said revised message;
a set surrounding display for said revised message;
a set text, icon, picture, or mark; and
an altered style for the message address field.

16. The method of claim 1, wherein said revision is comprised in an archiving of said instant messaging communications session.

17. The method of claim 1, further comprising the step of:
said message being within a preset number of messages sent by said instant message sender from the last message sent by said instant message sender.

18. The method of claim 1, further comprising the step of:
said revision constituting less than a preset amount of alterations.

19. The method of claim 1, further comprising the step of:
said message being already revised by less than a preset number of times.

20. The method of claim 1, wherein the client system that display said user interface for said instant messaging communications session is any of the following:
a desktop computer;
a portable computer;
a set-top box;
a game console;
a PDA; or
a cellular phone.
